(19) United States
(12) Patent Application Publication
(10) Pub. No.: US 2026/0286656 A1
(43) Pub. Date: Sep. 24, 2026

(54) SYSTEM, METHOD, AND NON-TRANSITORY COMPUTER-READABLE STORAGE MEDIUM STORING PROGRAM

(71) Applicant: KOMATSU LTD., Tokyo (JP)

(72) Inventor: Shinya HINO, Tokyo (JP)

(73) Assignee: KOMATSU LTD., Tokyo (JP)

(21) Appl. No.: 19/469,348

(22) PCT Filed: Mar. 28, 2024
(86) PCT No.: PCT/JP2024/012614

§ 371 Date: Sep. 25, 2025

(30) Foreign Application Priority Data
Mar. 28, 2023 (JP) 2023-052103

(51) Int. Cl. E02F 9/24; E02F 9/20; E02F 9/26

(52) U.S. Cl. CPC E02F 9/24; E02F 9/2033; E02F 9/262; E02F 9/265

(57) ABSTRACT

A system (200) includes a processor (210). The processor identifies a virtual wall (VW), which is a surface that prohibits entry of a work implement (160). The processor identifies a position of a control point (P) of a work tool (163) in a work machine (100). The processor identifies an offset wall (OW) obtained by bringing the virtual wall closer to the control point in a normal direction of the virtual wall by a length of a radius of a virtual sphere (VS) defined such that the virtual sphere includes the work tool with the control point as a center. The processor controls the work machine such that the offset wall does not come into contact with the control point.

### TECHNICAL FIELD

The present disclosure relates to a system, a method, and a program.

The present application claims priority based on Japanese Patent Application No. 2023-052103, filed Mar. 28, 2023, the content of which is incorporated herein by reference.

### BACKGROUND ART

There is a known technique for setting virtual walls in a space in order to limit the operating range of a work machine. A control device for the work machine can control the work machine such that it does not exceed the virtual wall by limiting the amount of movement of an actuator of the work machine in accordance with the distance between the virtual wall and the work machine.

Furthermore, Patent Document 1 discloses a technique for preventing a work tool from entering an interference prevention area by defining a virtual circle having a center on the rotation axis of the work tool and a radius to the tip end of the work tool, and determining the relationship between the virtual circle and the interference prevention area.

### CITATION LIST

### Patent Literature

Patent Document 1: JP H9-256403 A

### SUMMARY OF INVENTION

### Technical Problem

The closest point between the virtual wall and the work tool provided in the work machine changes depending on the posture of the work tool. Therefore, when trying to obtain the exact distance between the virtual wall and the work tool, it is necessary to obtain the distance between each of a plurality of contour points of the work tool and the virtual wall, which requires a large amount of calculation. As described in Patent Document 1, even to obtain the relationship between a virtual circle and a virtual wall, it is necessary to solve a quadratic equation that shows the relationship between a circle and a straight line, which requires a large amount of calculation.

An object of the present disclosure is to provide a system, a method, and a program that can limit the operation of a work machine such that a work tool does not enter a virtual wall, with a small amount of calculation.

### Solution to Problem

A system according to a first aspect of the present disclosure controls a work machine including a work implement provided with a work tool at a tip end. The system includes a processor. The processor identifies a virtual wall, which is a surface that prohibits entry of the work implement. The processor identifies a position of a control point of the work tool in the work machine. The processor identifies an offset wall obtained by bringing the virtual wall closer to the control point in a normal direction of the virtual wall by a length of a radius of a virtual sphere defined such that the virtual sphere includes the work tool with the control point as a center. The processor controls the work machine such that the offset wall does not come into contact with the control point.

A method according to a second aspect of the present disclosure is a method for controlling a work machine including a work implement provided with a work tool at a tip end, the method including a virtual wall identification step, a control point identification step, an offset step, and a control step. In the virtual wall identification step, a virtual wall, which is a surface that prohibits entry of the work implement, is identified. In the control point identification step, a position of a control point of the work tool in the work machine is identified. In the offset step, an offset wall is identified. The offset wall is obtained by bringing the virtual wall closer to the control point in a normal direction of the virtual wall by a length of a radius of a virtual sphere defined such that the virtual sphere includes the work tool with the control point as a center. In the control step, the work machine is controlled such that the offset wall does not come into contact with the control point.

A program according to a third aspect of the present disclosure causes a computer that controls a work machine including a work implement provided with a work tool at a tip end to execute a virtual wall identification step, a control point identification step, an offset step, and a control step. In the virtual wall identification step, a virtual wall, which is a surface that prohibits entry of the work implement, is identified. In the control point identification step, a position of a control point of the work tool in the work machine is identified. In the offset step, an offset wall is identified. The offset wall is obtained by bringing the virtual wall closer to the control point in a normal direction of the virtual wall by a length of a radius of a virtual sphere defined such that the virtual sphere includes the work tool with the control point as a center. In the control step, the work machine is controlled such that the offset wall does not come into contact with the control point.

### Advantageous Effects of Invention

According to at least one of the above aspects, it is possible to limit the operation of the work machine such that the work tool does not enter the virtual wall, with a small amount of calculation.

### BRIEF DESCRIPTION OF DRAWINGS

FIG. 1 is a schematic diagram illustrating a configuration of a work machine according to a first embodiment.

FIG. 2 is a diagram illustrating a drive system of the work machine according to the first embodiment.

FIG. 3 is a schematic block diagram illustrating a configuration of a control device according to the first embodiment.

FIG. 4 is a diagram illustrating a relationship between a virtual sphere and a virtual wall in the first embodiment.

FIG. 5 is a diagram illustrating a relationship between a virtual sphere and an outer shell of a bucket in the first embodiment.

FIG. 6 is a diagram illustrating an example of resetting of the virtual wall in association with the revolution of a revolving body in the first embodiment.

FIG. 7 is a flowchart (part 1) showing update and intervention control of the virtual wall set in the first embodiment.

FIG. 8 is a flowchart (part 2) showing update and intervention control of the virtual wall set in the first embodiment.

FIG. 9 is a diagram illustrating a relationship between a control point and a virtual sphere according to a modification example of the first embodiment.

FIG. 10 is a diagram illustrating a configuration of an attachment according to a second embodiment.

FIG. 11 is a diagram illustrating an example of control points and a virtual sphere according to the second embodiment.

FIG. 12 is a diagram illustrating a configuration of an attachment according to a third embodiment.

FIG. 13 is a diagram illustrating an example of control points and a virtual sphere according to the third embodiment.

FIG. 14 is a diagram illustrating a configuration of a work system according to another embodiment.

### DESCRIPTION OF EMBODIMENTS

### First Embodiment

### Configuration of Work Machine

Hereinafter, embodiments will be described in detail with reference to the drawings.

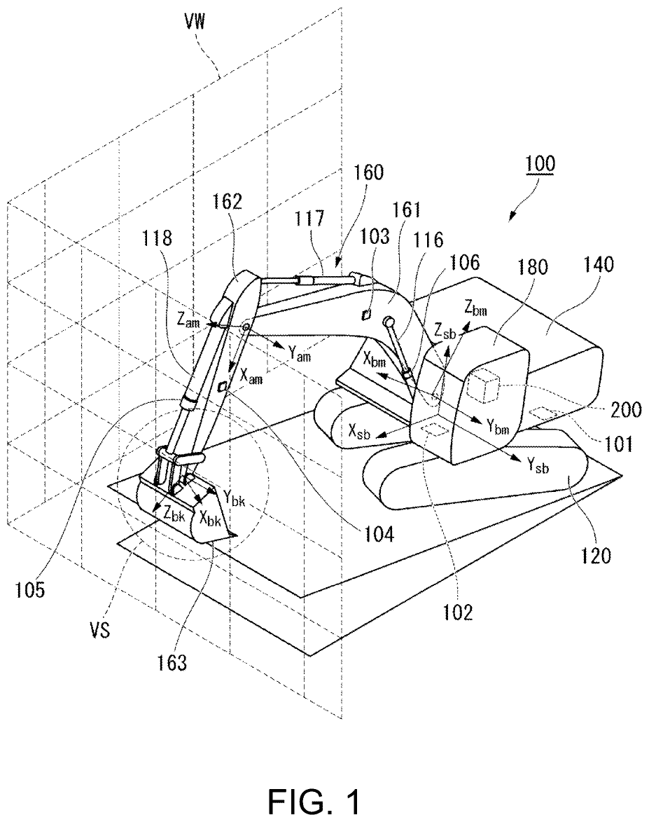

FIG. 1 is a schematic diagram illustrating a configuration of a work machine 100 according to a first embodiment. The work machine 100 according to the first embodiment is, for example, a hydraulic excavator. The work machine 100 includes a traveling body 120, a revolving body 140, a work implement 160, a cab 180, and a control device 200. The work machine 100 according to the first embodiment generates a virtual wall VW through operation by an operator, and is controlled such that the work machine 100 does not come into contact with the virtual wall VW. This enables the operator to operate the work machine 100 so as not to enter the restricted area.

The traveling body 120 supports the work machine 100 such that the work machine 100 can travel. The traveling body 120 is, for example, a pair of left and right endless tracks.

The revolving body 140 is supported by the traveling body 120 to be capable of revolving about a revolution center.

The work implement 160 is operably supported on the revolving body 140. The work implement 160 is hydraulically driven. The work implement 160 includes a boom 161, an arm 162, and an attachment 163 which is a working tool. The attachment 163 is an example of a work tool. The attachment 163 in the example illustrated in FIG. 1 is a bucket. A base end portion of the boom 161 is pivotally attached to the revolving body 140. A base end portion of the arm 162 is pivotally attached to a tip end portion of the boom 161. The attachment 163 is pivotally attached to a tip end portion of the arm 162. Here, a portion of the revolving body 140 to which the work implement 160 is attached is referred to as a front portion. In addition, with respect to the revolving body 140, with the front portion being taken as the reference portion, a portion on a side opposite thereto is referred to as a rear portion, a portion on the left side is referred to as a left portion, and a portion on the right side is referred to as a right portion.

The cab 180 is provided at the front portion of the revolving body 140. In the cab 180, an operation device 141 for the operator to operate the work machine 100, and a monitor device 142 which is a man-machine interface for the control device 200 are provided. The monitor device 142 is realized by, for example, a computer equipped with a touch panel.

The control device 200 controls the traveling body 120, the revolving body 140, and the work implement 160, based on the operation of the operation device by the operator. The control device 200 is provided, for example, inside the cab 180.

### Drive System of Work Machine 100

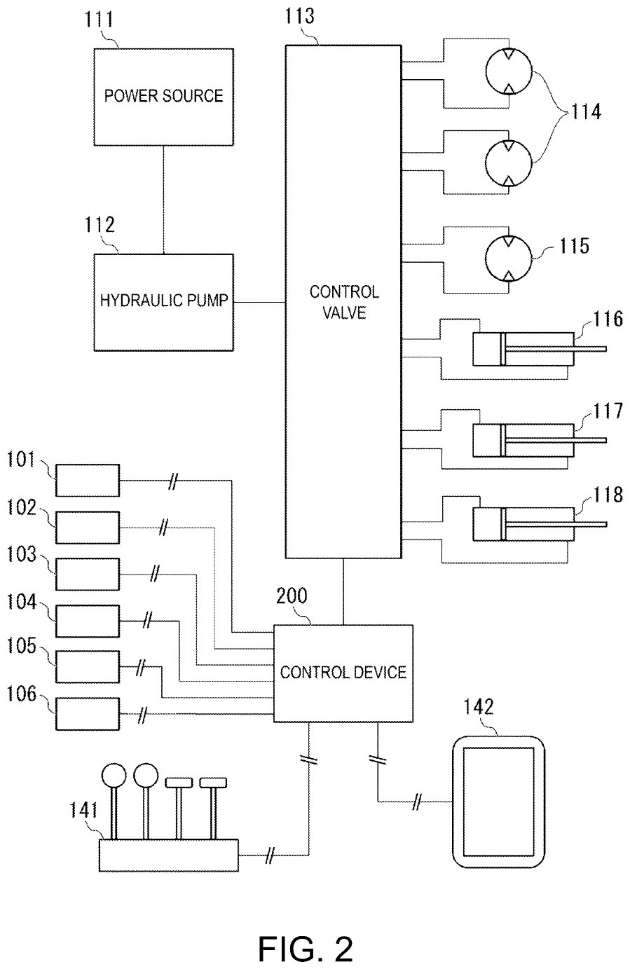

FIG. 2 is a diagram illustrating a drive system of the work machine 100 according to the first embodiment.

The work machine 100 includes a plurality of actuators for driving the work machine 100. Specifically, the work machine 100 includes a power source 111, a hydraulic pump 112, a control valve 113, a pair of travel motors 114, a revolution motor 115, a boom cylinder 116, an arm cylinder 117, and an attachment cylinder 118.

The power source 111 drives the hydraulic pump 112. The power source 111 is, for example, an engine.

The hydraulic pump 112 is driven by the power source 111 and supplies hydraulic oil to the travel motor 114, the revolution motor 115, the boom cylinder 116, the arm cylinder 117, and the attachment cylinder 118 via the control valve 113.

The control valve 113 controls the flow rate of hydraulic oil supplied from the hydraulic pump 112 to the travel motor 114, the revolution motor 115, the boom cylinder 116, the arm cylinder 117, and the attachment cylinder 118.

The travel motor 114 is driven by hydraulic oil supplied from the hydraulic pump 112 to drive the traveling body 120.

The revolution motor 115 is driven by hydraulic oil supplied from the hydraulic pump 112 to revolve the revolving body 140 relative to the traveling body 120.

The boom cylinder 116 is a hydraulic cylinder for driving the boom 161. A base end portion of the boom cylinder 116 is attached to the revolving body 140. A tip end portion of the boom cylinder 116 is attached to the boom 161.

The arm cylinder 117 is a hydraulic cylinder for driving the arm 162. A base end portion of the arm cylinder 117 is attached to the boom 161. A tip end portion of the arm cylinder 117 is attached to the arm 162.

The attachment cylinder 118 is a hydraulic cylinder for driving the attachment 163. A base end portion of the attachment cylinder 118 is attached to the arm 162. A tip end portion of the attachment cylinder 118 is attached to the attachment 163.

### Measurement System of Work Machine 100

The work machine 100 includes a plurality of sensors for measuring the posture and position of the work machine 100. Specifically, the work machine 100 includes an inclination measuring instrument 101, a revolution angle sensor 102, a boom angle sensor 103, an arm angle sensor 104, an attachment angle sensor 105, and a payload meter 106.

The inclination measuring instrument 101 measures the posture of the revolving body 140. The inclination measuring instrument 101 measures the inclination (for example, a roll angle, a pitch angle, and a yaw angle) of the revolving body 140 with respect to a horizontal plane. An example of the inclination measuring instrument 101 is an inertial measurement unit (IMU). In this case, the inclination measuring instrument 101 measures the acceleration and angular velocity of the revolving body 140, and calculates an inclination of the revolving body 140 with respect to the horizontal plane, based on the measurement results. The inclination measuring instrument 101 is installed, for example, below the cab 180. The inclination measuring instrument 101 outputs the posture data of the revolving body 140, which is a measurement value, to the control device 200.

The revolution angle sensor 102 measures a revolution angle of the revolving body 140 relative to the traveling body 120. The measurement value of the revolution angle sensor 102 indicates zero, for example, when the directions of the traveling body 120 and the revolving body 140 coincide with each other. The revolution angle sensor 102 is installed, for example, at the revolution center of the revolving body 140. The revolution angle sensor 102 outputs revolution angle data, which is a measurement value, to the control device 200.

The boom angle sensor 103 measures a boom angle, which is a rotation angle of the boom 161 relative to the revolving body 140. The boom angle sensor 103 may be an IMU attached to the boom 161. In this case, the boom angle sensor 103 measures the boom angle, based on the inclination of the boom 161 with respect to the horizontal plane and the inclination of the revolving body measured by the inclination measuring instrument 101. The measurement value of the boom angle sensor 103 indicates zero when, for example, the direction of a straight line passing through the base end and the tip end of the boom 161 coincides with the front-rear direction of the revolving body 140. Note that the boom angle sensor 103 according to another embodiment may be a stroke sensor attached to the boom cylinder 116. Furthermore, the boom angle sensor 103 according to another embodiment may be a rotation sensor provided on a pin connecting the revolving body 140 and the boom 161. The boom angle sensor 103 outputs boom angle data, which is a measurement value, to the control device 200.

The arm angle sensor 104 measures an arm angle, which is a rotation angle of the arm 162 relative to the boom 161. The arm angle sensor 104 may be an IMU attached to the arm 162. In this case, the arm angle sensor 104 measures the arm angle, based on the inclination of the arm 162 with respect to the horizontal plane and the boom angle measured by the boom angle sensor 103. The measurement value of the arm angle sensor 104 indicates zero, for example, when the direction of a straight line passing through the base end and the tip end of the arm 162 coincides with the direction of a straight line passing through the base end and the tip end of the boom 161. In addition, the arm angle sensor 104 according to another embodiment may be configured such that a stroke sensor is attached to the arm cylinder 117 to calculate the angle. Furthermore, the arm angle sensor 104 according to another embodiment may be a rotation sensor provided on a pin connecting the boom 161 and the arm 162. The arm angle sensor 104 outputs arm angle data, which is a measurement value, to the control device 200.

The attachment angle sensor 105 measures an attachment angle, which is a rotation angle of the attachment 163 relative to the arm 162. The attachment angle sensor 105 may be a stroke sensor provided on the attachment cylinder 118 for driving the attachment 163. In this case, the attachment angle sensor 105 measures the attachment angle, based on the stroke amount of the attachment cylinder 118. The measurement value of the attachment angle sensor 105 indicates zero, for example, when the direction of a straight line passing through the base end and the tip end portion of the attachment 163 coincides with the direction of a straight line passing through the base end and the tip end of the arm 162. Note that the attachment angle sensor 105 according to another embodiment may be a rotation sensor provided on a pin connecting the arm 162 and the attachment 163. In addition, the attachment angle sensor 105 according to another embodiment may be an IMU attached to the attachment 163. The attachment angle sensor 105 outputs attachment angle data, which is a measurement value, to the control device 200.

The payload meter 106 measures a weight of the load held by the attachment 163. The payload meter 106 measures, for example, a bottom pressure of the cylinder of the boom 161 and converts the bottom pressure into the weight of the load. Also, for example, the payload meter 106 may be a load cell. The payload meter 106 outputs load weight data, which is a measurement value, to the control device 200.

### Configuration of Control Device 200

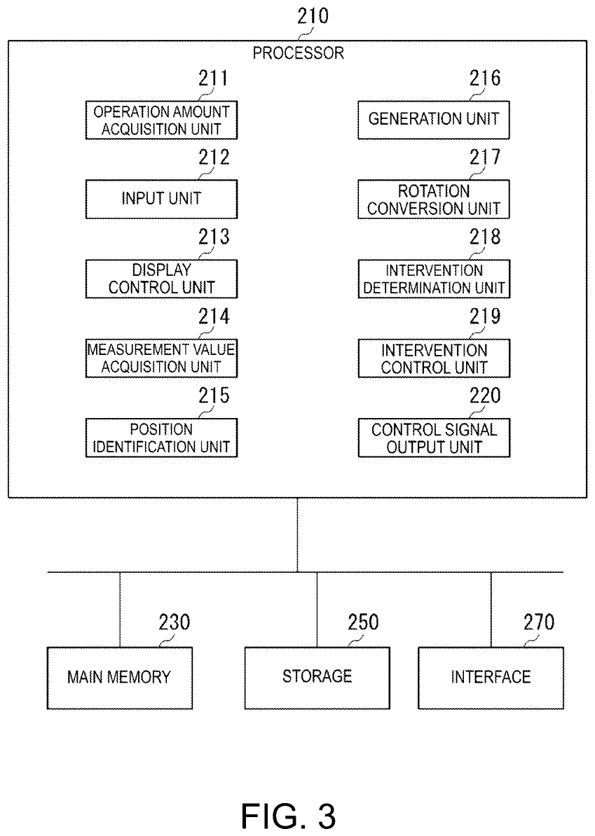

FIG. 3 is a schematic block diagram illustrating a configuration of the control device 200 according to the first embodiment.

The control device 200 is a computer including a processor 210, a main memory 230, a storage 250, and an interface 270. The control device 200 is an example of a control system. The control device 200 receives measurement values from the inclination measuring instrument 101, the revolution angle sensor 102, the boom angle sensor 103, the arm angle sensor 104, the attachment angle sensor 105, and the payload meter 106.

The storage 250 is a non-transitory, tangible storage medium. Examples of the storage 250 include a magnetic disk, an optical disc, a magneto-optical disk, and a semiconductor memory. The storage 250 may be an internal medium directly connected to the bus of the control device 200, or may be an external medium connected to the control device 200 via the interface 270 or a communication line. The storage 250 stores a control program for controlling the work machine 100.

The control program may be a program for realizing a part of the functions to be exhibited by the control device 200. For example, the control program may be a program that exhibits a function in combination with other programs already stored in the storage 250 or in combination with other programs implemented in other devices. In addition, in other embodiments, the control device 200 may include, in addition to or instead of the above configuration, a custom large scale integrated circuit (LSI) such as a programmable logic device (PLD). Examples of the PLD include a programmable array logic (PAL), a generic array logic (GAL), a complex programmable logic device (CPLD), and a field programmable gate array (FPGA). In this case, some or all of the functions realized by the processor may be realized by the integrated circuit.

The storage 250 records geometry data representing the dimensions and the center of gravity positions of the revolving body 140, the boom 161, the arm 162, and the attachment 163. Geometry data is data that represents the position of an object in a predetermined coordinate system. Furthermore, the storage 250 stores, for each model number of the attachment 163, geometry data relating to the attachment 163 of the corresponding model number.

### Software Configuration

By executing the control program, the processor 210 includes an operation amount acquisition unit 211, an input unit 212, a display control unit 213, a measurement value acquisition unit 214, a position identification unit 215, a generation unit 216, a rotation conversion unit 217, an intervention determination unit 218, an intervention control unit 219, and a control signal output unit 220.

The operation amount acquisition unit 211 acquires an operation signal indicating an operation amount of each actuator from the operation device 141.

The input unit 212 receives an operation input by an operator via the monitor device 142. In particular, when the attachment 163 is replaced, the input unit 212 receives an input of the model number of the attachment 163. Accordingly, the processor 210 reads the geometry data associated with the corresponding model number from the storage 250.

The display control unit 213 outputs screen data to be displayed on the monitor device 142 to the monitor device 142.

The measurement value acquisition unit 214 acquires measurement values from the inclination measuring instrument 101, the revolution angle sensor 102, the boom angle sensor 103, the arm angle sensor 104, the attachment angle sensor 105, and the payload meter 106.

The position identification unit 215 identifies a position of an outer shell of the work machine 100 in a vehicle body coordinate system. The outer shell of the work machine 100 refers to an outer shape of the work machine 100. The outer shell of the work machine 100 is defined by shapes that form the outer shapes of the revolving body 140 and the work implement 160, for example. Specifically, the position identification unit 215 identifies a plurality of points on the outer shell of the work machine 100 in the vehicle body coordinate system and a position of a control point P of the attachment 163, based on the various measurement values acquired by the measurement value acquisition unit 214, and the geometry data recorded in the storage 250. The plurality of points on the outer shell identified by the position identification unit 215 include an end of the arm 162 on the attachment 163 side (arm top), an end of the arm 162 on the boom 161 side (arm bottom), and a point behind a counterweight of the revolving body 140. The vehicle body coordinate system is an orthogonal coordinate system whose origin is a representative point of the revolving body 140 (for example, a point passing through the revolution center). The calculations of the position identification unit 215 will be described later. Note that the points identified by the position identification unit 215 are not limited thereto.

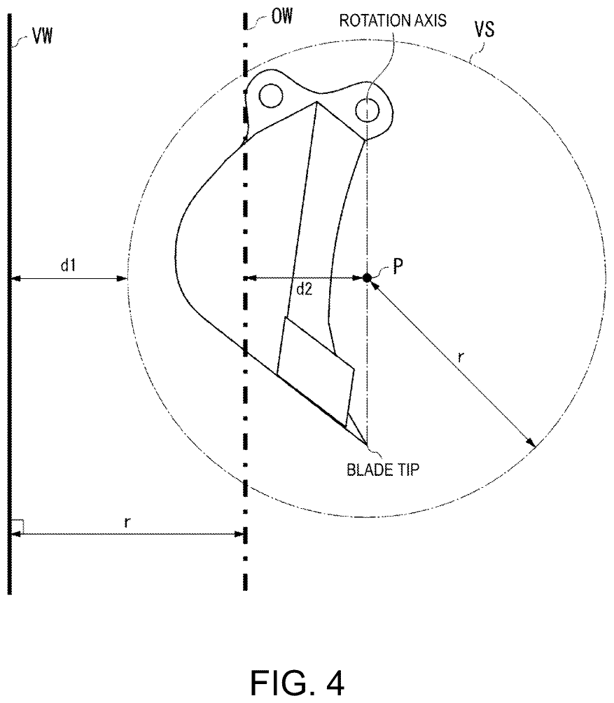

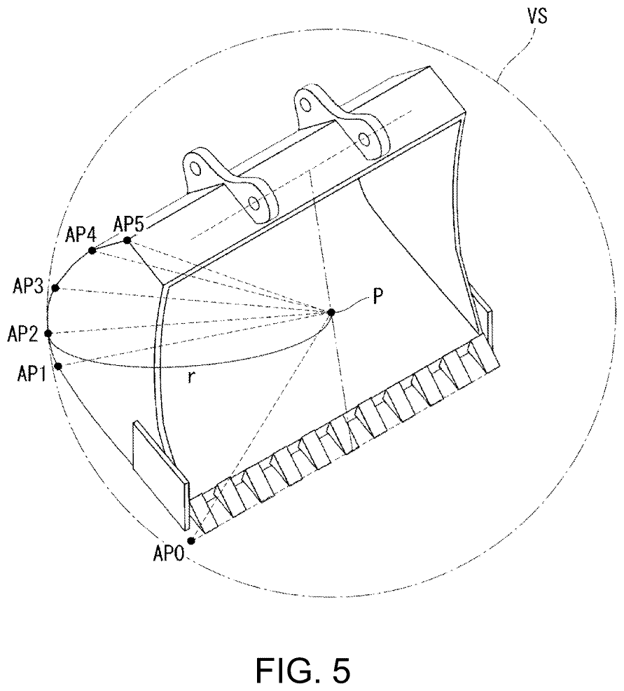

The control point P of the attachment 163 is the center of a virtual sphere VS when the attachment 163 is regarded as a sphere (virtual sphere VS). In order to simply represent the attachment 163, the virtual sphere VS is defined so as to include the attachment 163 with the control point P as its center. FIG. 4 is a diagram illustrating a relationship between the virtual sphere VS and the virtual wall VW in the first embodiment. FIG. 5 is a diagram illustrating a relationship between the virtual sphere VS and the outer shell of the bucket in the first embodiment. In the first embodiment, the attachment 163 is a bucket, and as illustrated in FIGS. 4 and 5, the control point P is a midpoint of a line segment connecting a midpoint of a pin (rotation axis) connecting the arm 162 and the bucket and a midpoint of a blade tip (tip end portion) of the bucket. A radius r of the virtual sphere VS in the first embodiment is equal to a distance from the control point P to the farthest point on the outer shell of the bucket. Therefore, the virtual sphere VS includes the bucket. In the example of FIG. 5, points AP0, AP1, AP2, AP3, AP4, and AP5 are identified as points for simply expressing the outer shell of the bucket, and among these, the point farthest from the control point P is AP2. Therefore, in the example of FIG. 5, the radius r is equal to a distance from the control point P to the point AP2.

By setting the control point P of the bucket at the midpoint of the line segment connecting the midpoint of the rotation axis of the bucket and the midpoint of the tip end portion of the bucket, the gap between the bottom surface of the bucket and the virtual sphere VS can be reduced. On the other hand, the opening surface of the bucket is at a greater distance from the virtual sphere VS than the bottom surface, but in a backhoe excavator, the opening surface of the bucket does not normally face the front of the work machine 100, and thus there are few situations in which this affects operability. In addition, since the shape of the bucket is close to a hemisphere, setting the control point P to the midpoint of the line segment connecting the midpoint of the rotation axis of the bucket and the midpoint of the tip end portion of the bucket has an advantage of making it easier for the operator to imagine the virtual sphere VS when operating the bucket.

When the input unit 212 receives an instruction to generate the virtual wall VW from an operator, the generation unit 216 calculates parameters of the virtual wall VW, based on the position of the tip end portion of the attachment 163 identified by the position identification unit 215. The generation unit 216 records the parameters of the generated virtual wall VW in the vehicle body coordinate system in the main memory 230.

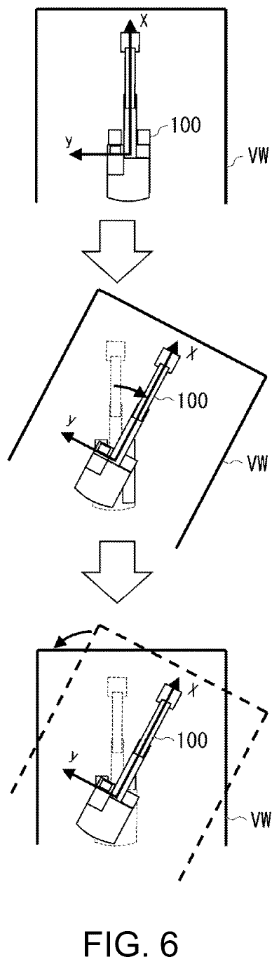

The rotation conversion unit 217 updates the parameters of the virtual wall VW stored in the main memory 230 as the revolving body 140 revolves. Specifically, the rotation conversion unit 217 performs rotation conversion on the parameters of the virtual wall VW around the origin of the vehicle body coordinate system by the amount of change in the pitch angle, the roll angle, and the yaw angle measured by the inclination measuring instrument 101. FIG. 6 is a diagram illustrating an example of resetting the virtual wall VW in association with the revolution of the revolving body in the first embodiment. For example, as illustrated in FIG. 6, when the revolving body 140 revolves after the virtual wall VW is set, the rotation conversion unit 217 calculates the amount of change in the roll angle, the pitch angle, and the yaw angle caused by the revolution of the revolving body 140 by referring to the measurement values of the inclination measuring instrument 101 acquired by the measurement value acquisition unit 214, and performs rotation conversion on the parameters of the virtual wall VW around the origin of the vehicle body coordinate system. This enables the rotation conversion unit 217 to cancel the rotation of the virtual wall VW caused by the revolution of the revolving body 140.

The intervention determination unit 218 determines whether or not to limit the revolution speed of the revolving body 140 or the speed of the work implement 160, based on a positional relationship between the plurality of points of the outer shell identified by the position identification unit 215 and the virtual wall VW, and a positional relationship between the virtual sphere VS of the attachment 163 and the virtual wall VW. Hereinafter, limiting the speed of the revolving body 140 or the work implement 160 by the control device 200 is also referred to as intervention control. Specifically, the intervention determination unit 218 obtains the minimum revolution angle at which the virtual wall VW comes into contact with at least one of the plurality of points on the outer shell, and when the minimum revolution angle is equal to or less than a predetermined angle, the intervention determination unit 218 determines that intervention control is to be performed on the revolving body 140. In addition, the intervention determination unit 218 obtains a minimum distance between the virtual wall VW and the work implement 160, and when the minimum distance is equal to or less than a predetermined distance, the intervention determination unit 218 determines that intervention control should be performed on the work implement 160. At this time, the intervention determination unit 218 obtains the distance to the attachment 163, based on the virtual sphere VS. In order to reduce the amount of calculation, the intervention determination unit 218 identifies an offset wall OW obtained by offsetting the virtual wall VW by the radius r of the virtual sphere VS as illustrated in FIG. 4. A distance d1 between the virtual sphere VS and the virtual wall VW is equal to a distance d2 between the control point P and the offset wall OW. Therefore, the intervention determination unit 218 calculates the distance d2 between the control point P and the offset wall OW to obtain the distance d1 between the virtual sphere VS and the virtual wall VW.

When the intervention determination unit 218 determines that intervention control is to be performed, the intervention control unit 219 controls the operation amount of the intervention target among the operation amounts acquired by the operation amount acquisition unit 211.

The control signal output unit 220 outputs the operation amount acquired by the operation amount acquisition unit 211 or the operation amount controlled by the intervention determination unit 218 to the control valve 113.

### Calculation of Position Identification Unit 215

Here, a method for identifying the positions of points on the outer shell of the work machine 100 by the position identification unit 215 will be described. The position identification unit 215 identifies the positions of the points on the outer shell, based on the various measurement values acquired by the measurement value acquisition unit 214 and the geometry data recorded in the storage 250. The storage 250 records geometry data representing the dimensions and the center of gravity positions of the revolving body 140, the boom 161, the arm 162, and the attachment 163.

The geometry data of the revolving body 140 indicates the positions (x_{bm}, y_{bm}, z_{bm}) of the pins supporting the boom 161 of the revolving body 140 in the vehicle body coordinate system, which is a local coordinate system, and the positions (xₛₚ, yₛₚ, zₛₚ) of points on the outer shell of the revolving body 140. Examples of points on the outer shell of the revolving body 140 include points that are likely to come into contact with a wall surface when revolving, such as protruding points of a counterweight. The vehicle body coordinate system is a coordinate system that is configured with an X_{sb} axis extending in the front-rear direction, a Y_{sb} axis extending in the left-right direction, and a Z_{sb} axis extending in the up-down direction, with reference to the revolution center of the revolving body 140. The up-down direction of the revolving body 140 does not necessarily coincide with the vertical direction.

The geometry data of the boom 161 indicates the position (xₐₘ, yₐₘ, zₐₘ) of the boom top in a boom coordinate system, which is a local coordinate system. The boom coordinate system is a coordinate system that is configured with an X_{bm} axis extending in the longitudinal direction, a Y_{bm} axis extending in the direction in which the pin extends, and a Z_{bm} axis orthogonal to the X_{bm} axis and the Y_{bm} axis, with reference to the position of the pin connecting the boom 161 and the revolving body 140. The position of the boom top is the position of the pin that connects the boom 161 and the arm 162. The boom top is a point on the outer shell of the work machine 100.

The geometry data of the arm 162 indicates the position (xₐₜ, yₐₜ, zₐₜ) of the arm top in an arm coordinate system, which is a local coordinate system. The arm coordinate system is a coordinate system that is configured with an Xₐₘ axis extending in the longitudinal direction, a Yₐₘ axis extending in the direction in which the pin extends, and a Zₐₘ axis orthogonal to the Xₐₘ axis and the Yₐₘ axis, with reference to the position of the pin connecting the arm 162 and the boom 161. The position of the arm top is the position of the pin that connects the arm 162 and the attachment 163. The arm top is a point on the outer shell of the work machine 100.

The geometry data of the attachment 163 indicates the position (xcp, ycp, zcp) of the control point P of the attachment 163 in the attachment coordinate system, which is a local coordinate system. The attachment coordinate system is a coordinate system that is configured with an Xₐₜ axis extending in the direction of the tip end portion, a Yₐₜ axis extending in the direction in which the pin extends, and a Zₐₜ axis orthogonal to the Xₐₜ axis and the Yₐₜ axis, with reference to the position of the pin connecting the attachment 163 and the arm 162. That is, the control point P is a point that is uniquely identified in a coordinate system based on the attachment 163.

The position identification unit 215 generates a boom-vehicle body transformation matrix T^{bm}_{sb} for transforming from the boom coordinate system to the vehicle body coordinate system, based on a measurement value of a boom angle θ_{bm} acquired by the measurement value acquisition unit 214 and the geometry data of the revolving body 140, using the following equation (1). The boom-vehicle body transformation matrix T^{bm}_{sb} is a matrix that rotates by the boom angle θ_{bm} around the Y_{bm} axis and translates by the deviation (x_{bm}, y_{bm}, z_{bm}) between the origin of the vehicle body coordinate system and the origin of the boom coordinate system.

In addition, the position identification unit 215 obtains the product of the position of the boom top in the boom coordinate system indicated by the geometry data of the boom 161 and the boom-vehicle body transformation matrix T^{bm}_{sb}, thereby obtaining the position of the boom top in the vehicle body coordinate system.

$$\begin{matrix}[ Math . 1 ] & \\ {T}_{sb}^{bm} = [ \begin{matrix}cos {θ}_{bm} & 0 & sin {θ}_{bm} & {x}_{bm} \\ 0 & 1 & 0 & {y}_{bm} \\ - sin {θ}_{bm} & 0 & cos {θ}_{bm} & {z}_{bm} \\ 0 & 0 & 0 & 1\end{matrix} ] & ( 1 )\end{matrix}$$

The position identification unit 215 generates an arm-boom transformation matrix T^{am}_{bm} for transforming from the arm coordinate system to the boom coordinate system, based on a measurement value of an arm angle θₐₘ acquired by the measurement value acquisition unit 214 and the geometry data of the boom 161, using the following equation (2). The arm-boom transformation matrix T^{am}_{bm} is a matrix that rotates by the arm angle θₐₘ around the Yₐₘ axis and translates by the deviation (xₐₘ, yₐₘ, zₐₘ) between the origin of the boom coordinate system and the origin of the arm coordinate system. In addition, the position identification unit 215 generates an arm-vehicle body transformation matrix T^{am}_{sb} for transforming from the arm coordinate system to the vehicle body coordinate system by obtaining the product of the boom-vehicle body transformation matrix T^{bm}_{sb} and the arm-boom transformation matrix T^{am}_{bm}. In addition, the position identification unit 215 obtains the product of the position of the arm top in the arm coordinate system indicated by the geometry data of the arm 162 and the arm-vehicle body transformation matrix T^{am}_{sb}, thereby obtaining the position of the arm top in the vehicle body coordinate system.

$$\begin{matrix}[ Math . 2 ] & \\ {T}_{bm}^{am} = [ \begin{matrix}cos {θ}_{am} & 0 & sin {θ}_{am} & {x}_{am} \\ 0 & 1 & 0 & {y}_{am} \\ - sin {θ}_{am} & 0 & cos {θ}_{am} & {z}_{am} \\ 0 & 0 & 0 & 1\end{matrix} ] & ( 2 )\end{matrix}$$

The position identification unit 215 generates an attachment-arm transformation matrix T^{at}ₐₘ for transforming from the attachment coordinate system to the arm coordinate system, based on a measurement value of an attachment angle θₐₜ acquired by the measurement value acquisition unit 214 and the geometry data of the arm 162, using the following equation (3). The attachment-arm transformation matrix T^{at}ₐₘ is a matrix that rotates by the attachment angle θₐₜ around the Yₐₜ axis and translates by the deviation (xₐₜ, yₐₜ, zₐₜ) between the origin of the arm coordinate system and the origin of the attachment coordinate system. In addition, the position identification unit 215 generates an attachment-vehicle body transformation matrix T^{at}_{sb} for transforming from the attachment coordinate system to the vehicle body coordinate system by obtaining the product of the arm-vehicle body transformation matrix T^{am}_{sb} and the attachment-arm transformation matrix T^{at}ₐₘ.

$$\begin{matrix}[ Math . 3 ] & \\ {T}_{am}^{at} = [ \begin{matrix}cos {θ}_{at} & 0 & sin {θ}_{at} & {x}_{at} \\ 0 & 1 & 0 & {y}_{at} \\ - sin {θ}_{at} & 0 & cos {θ}_{at} & {z}_{at} \\ 0 & 0 & 0 & 1\end{matrix} ] & ( 3 )\end{matrix}$$

The position identification unit 215 obtains the position of the control point P of the attachment 163 in the vehicle body coordinate system by obtaining the product of the position of the control point P in the attachment coordinate system indicated by the geometry data of the attachment 163 and the attachment-vehicle body transformation matrix T^{at}_{sb}.

### Control Method for Work Machine 100

Hereinafter, a control method for the work machine 100 according to the first embodiment will be described.

First, the operator of the work machine 100 operates the monitor device 142 to set the virtual wall VW. When the input unit 212 receives an instruction to set a virtual wall VW from the monitor device 142, the display control unit 213 causes the monitor device 142 to display a selection screen for the type of the virtual wall VW to be set. The control device 200 can set five types of virtual walls VW: a front wall, a left wall, a right wall, an upper wall, and a lower wall. The front wall, the left wall, and the right wall are wall surfaces that extend in the vertical direction. The upper wall and the lower wall are wall surfaces that extend in the horizontal direction. The virtual wall VW is represented by a normal vector indicating the normal direction of the virtual wall VW and a position vector indicating the position of a point through which the virtual wall VW passes, both of which are defined in the vehicle body coordinate system.

The work machine 100 can perform work within the reach of the work implement 160 by revolving the revolving body 140. Therefore, typically, the operator revolves the work machine 100 when performing work such as excavation. The vehicle body coordinate system is based on the revolving body 140 and therefore rotates following the revolution of the work machine 100 when viewed from the viewpoint of the global coordinate system. When the virtual wall VW set in the vehicle body coordinate system rotates following the revolution of the work machine 100, the right wall and the left wall do not interfere with the work machine 100 and this is meaningless. For example, when a right wall is set on the right side of the revolving body 140, the right wall is always maintained on the right side of the revolving body 140 regardless of how the revolving body 140 is revolved and does not interfere with the work machine 100. Furthermore, when the front wall rotates following the revolution of the work machine 100, it behaves as an annular wall rather than a planar wall, and therefore does not function as a virtual wall VW along the wall surface of the building.

Therefore, the control device 200 according to the first embodiment performs a rotation conversion process of the virtual wall VW in order to maintain the position of the virtual wall VW in the global coordinate system before and after the work machine 100 revolves.

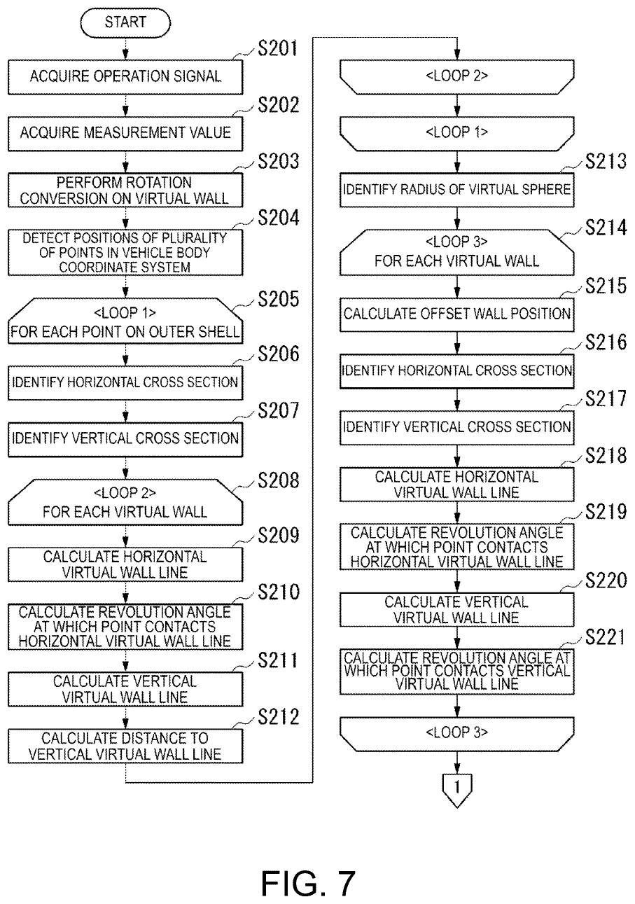

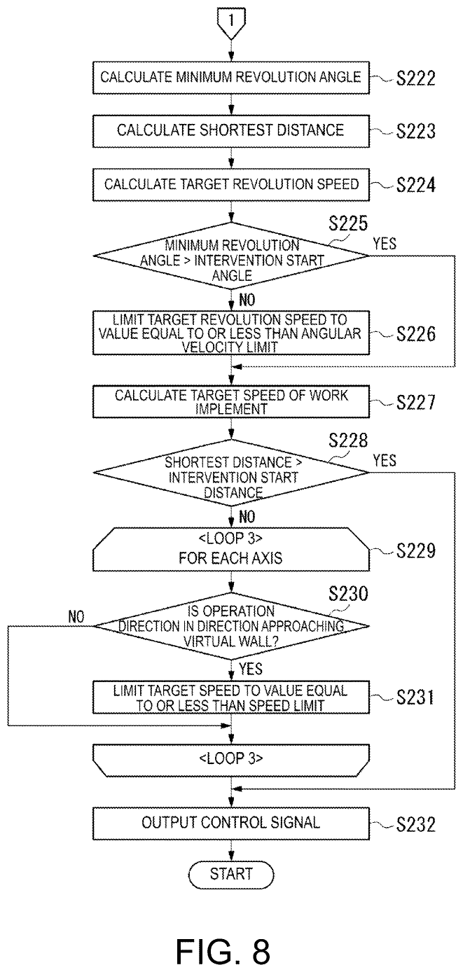

FIG. 7 is a flowchart (part 1) showing update and intervention control of the virtual wall VW set in the first embodiment. FIG. 8 is a flowchart (part 2) showing update and intervention control of the virtual wall VW set in the first embodiment. When the operator of the work machine 100 sets at least one virtual wall VW by operating the monitor device 142, the control device 200 starts the control described below.

The operation amount acquisition unit 211 acquires operation signals of the boom 161, the arm 162, the attachment 163, and the revolving body 140 from the operation device 141 (step S201). The measurement value acquisition unit 214 acquires the measurement values of the inclination measuring instrument 101, the revolution angle sensor 102, the boom angle sensor 103, the arm angle sensor 104, the attachment angle sensor 105, and the payload meter 106 (step S202).

The rotation conversion unit 217 rotationally converts and updates each of one or more virtual walls VW stored in the main memory 230, based on the roll angle, the pitch angle, and the yaw angle of the revolving body 140 acquired from the inclination measuring instrument 101 in step S202 (step S203).

The position identification unit 215 calculates the positions of a plurality of points on the outer shell of the work machine 100 and the control point P of the attachment 163 in the vehicle body coordinate system, based on the measurement values acquired in step S202 (step S204). The intervention determination unit 218 selects one by one from points on the outer shell identified by the position identification unit 215 (step S205), and executes the following processes from step S206 to step S212.

The intervention determination unit 218 identifies a cross section that passes through the point selected in step S205 and is parallel to the X_{sb}-Y_{sb} plane of the vehicle body coordinate system (step S206). Furthermore, the intervention determination unit 218 identifies a cross section that passes through the point selected in step S205 and is parallel to the X_{sb}-Z_{sb} plane of the vehicle body coordinate system (step S207).

The intervention determination unit 218 selects one by one from one or more virtual walls VW set in the main memory 230 (step S208), and executes the following processes from step S209 to step S212.

The intervention determination unit 218 calculates an intersection line between the cross section generated in step S206 and the virtual wall VW selected in step S208 as a horizontal virtual wall line (step S209). Depending on the positional relationship between the cross section generated in step S206 and the virtual wall VW, there may be cases where a horizontal virtual wall line does not exist. When a horizontal virtual wall line exists, the intervention determination unit 218 obtains the revolution angle at which the point selected in step S205 contacts the horizontal virtual wall line calculated in step S209 for each of the right revolution and the left revolution (step S210). For example, the intervention determination unit 218 calculates an intersection between a circle centered on the revolution center and passing through the point selected in step S205 and the horizontal virtual wall line, and obtains the angle between the line segment extending from the revolution center to the point selected in step S205 and the line segment extending from the revolution center to the intersection. Depending on the positional relationship between the point selected in step S205 and the horizontal virtual wall line, there may be cases where an intersection does not exist.

In addition, the intervention determination unit 218 calculates an intersection line between the cross section generated in step S207 and the virtual wall VW selected in step S208 as a vertical virtual wall line (step S211). Depending on the positional relationship between the cross section generated in step S207 and the virtual wall VW, there may be cases where a vertical virtual wall line does not exist. When a vertical virtual wall line exists, the intervention determination unit 218 obtains the distance between the point selected in step S205 and the vertical virtual wall line calculated in step S211 (step S212).

Next, the intervention determination unit 218 executes the following processes from step S213 to step S221 for the control point P of the attachment 163 identified in step S204. The intervention determination unit 218 identifies the radius r of the virtual sphere VS, based on the geometry data of the attachment 163 (step S213). The radius r of the virtual sphere VS may be included in the geometry data of the attachment 163, or may be obtained by calculating the distance between a point on the outer shell of the attachment 163 indicated in the geometry data and a reference point.

The intervention determination unit 218 selects one by one from one or more virtual walls VW set in the main memory 230 (step S214), and executes the following processes from step S215 to step S221.

The intervention determination unit 218 calculates the position of an offset wall OW obtained by offsetting the virtual wall VW selected in step S214 in the normal direction by the length of the radius r identified in step S213 (step S215). That is, the intervention determination unit 218 brings the virtual wall VW selected in step S214 closer to the control point P of the attachment 163 by the length of the radius r. The intervention determination unit 218 identifies a cross section that passes through the control point P of the attachment 163 and is parallel to the X_{sb}-Y_{sb} plane of the vehicle body coordinate system (step S216). Furthermore, the intervention determination unit 218 identifies a cross section that passes through the control point P of the attachment 163 and is parallel to the X_{sb}-Z_{sb} plane of the vehicle body coordinate system (step S217).

The intervention determination unit 218 calculates an intersection line between the cross section generated in step S216 and the offset wall OW obtained in step S215 as a horizontal virtual wall line (step S218). Depending on the positional relationship between the cross section generated in step S206 and the offset wall OW, there may be cases where a horizontal virtual wall line does not exist. When a horizontal virtual wall line exists, the intervention determination unit 218 obtains the revolution angle at which the control point P of the attachment 163 contacts the horizontal virtual wall line calculated in step S209 for each of the right revolution and the left revolution (step S219). This revolution angle is equivalent to the revolution angle at which the virtual sphere VS and the virtual wall VW come into contact with each other. For example, the intervention determination unit 218 calculates an intersection between a circle centered on the revolution center and passing through the control point P of the attachment 163 and the horizontal virtual wall line, and obtains the angle between the line segment extending from the revolution center to the control point P of the attachment 163 and the line segment extending from the revolution center to the intersection. Depending on the positional relationship between the control point P of the attachment 163 and the horizontal virtual wall line, there may be cases where an intersection does not exist.

In addition, the intervention determination unit 218 calculates an intersection line between the cross section generated in step S217 and the offset wall OW obtained in step S215 as a vertical virtual wall line (step S220). Depending on the positional relationship between the cross section generated in step S217 and the offset wall OW, there may be cases where a vertical virtual wall line does not exist. When a vertical virtual wall line exists, the intervention determination unit 218 obtains the distance between the control point P of the attachment 163 and the vertical virtual wall line calculated in step S220 (step S221). This distance is equivalent to the distance at which the virtual sphere VS and the virtual wall VW come into contact with each other.

The intervention determination unit 218 calculates the minimum revolution angle at which at least one of the plurality of points and the virtual sphere VS contacts at least one virtual wall VW for each of the right revolution and the left revolution, based on the revolution angles of each point on the work machine 100 and each virtual wall VW on the virtual sphere VS obtained in steps S210 and S219 (step S222).

The intervention determination unit 218 calculates the shortest distance between the work implement 160 and the virtual wall VW, based on the distances to each point on the work machine 100 and each virtual wall VW on the virtual sphere VS obtained in steps S212 and S221 (step S223).

The intervention determination unit 218 calculates the revolution direction and the target revolution speed, based on the operation signal of the revolving body 140 acquired in step S201 (step S224). The intervention determination unit 218 determines whether or not the minimum revolution angle in the revolution direction indicated by the operation signal is greater than the intervention start angle (step S225). When the minimum revolution angle is greater than the intervention start angle (step S225: YES), the intervention control unit 219 does not perform intervention control for the revolution. On the other hand, when the minimum revolution angle is equal to or less than the intervention start angle (step S225: NO), the intervention control unit 219 identifies the angular velocity limit from the minimum revolution angle, based on a predetermined angular velocity limit table, and limits the target revolution speed of the revolving body 140 to a value equal to or less than the angular velocity limit (step S226). The angular velocity limit table is a function that indicates the relationship between the minimum revolution angle and the angular velocity limit, and is a function in which the smaller the minimum revolution angle, the smaller the angular velocity limit.

The angular velocity limit table may be set to a deceleration rate that does not impair the operator's controllability of the revolving body 140, for example.

The intervention determination unit 218 calculates a target speed of the work implement 160, based on the operation signals of the boom 161, the arm 162, and the attachment 163 acquired in step S201 (step S227). Specifically, the intervention determination unit 218 calculates target speeds of the boom 161, the arm 162, and the attachment 163, based on the operation signals of the boom 161, the arm 162, and the attachment 163 acquired in step S201. Next, the intervention determination unit 218 determines whether or not the shortest distance calculated in step S223 is longer than the intervention start distance (step S228). When the shortest distance is longer than the intervention start distance (step S228: YES), the intervention control unit 219 does not perform intervention control for the work implement 160. On the other hand, when the shortest distance is equal to or less than the intervention start distance (step S228: NO), the intervention control unit 219 selects each axis of the work implement 160 one by one, and performs the following processes from steps S230 to S231 for the selected axis (step S229). The intervention control unit 219 determines whether or not the operation direction of the selected axis is an operation in a direction approaching the virtual wall VW (step S230). When the operation direction of the selected axis is not an operation in a direction approaching the virtual wall VW (step S230: NO), the intervention control unit 219 does not perform intervention control for the selected axis. On the other hand, when the operation direction of the selected axis is an operation in a direction approaching the virtual wall VW (step S230: YES), the intervention control unit 219 identifies the speed limit for the selected axis, based on a predetermined speed limit table, and limits the target speed to a value equal to or less than the speed limit (step S231).

The control signal output unit 220 generates a control signal, based on the target speeds of the boom 161, the arm 162, and the attachment 163 and the target angular velocity of the revolving body 140, and outputs the control signal to the control valve 113 (step S232).

### Actions and Effects

In this manner, the control device 200 controls the work machine 100 in the following procedure. The control device 200 identifies a virtual wall VW, which is a surface that prohibits entry of the work implement 160. The control device 200 identifies the position of a control point P of the attachment 163 in the work machine 100. The control device 200 identifies an offset wall OW that obtained by bringing the virtual wall VW closer to the control point P in the normal direction of the virtual wall VW by the length of the radius r of a virtual sphere VS centered at the control point P that includes the attachment 163. The control device 200 controls the work machine 100 such that the offset wall OW does not come into contact with the control point P. Accordingly, the control device 200 can calculate the positional relationship between the virtual sphere VS and the virtual wall VW through simple calculations using surfaces and points. Therefore, the control device 200 can limit the operation of the work machine 100 such that the attachment 163 does not enter the virtual wall VW, with a small amount of calculation.

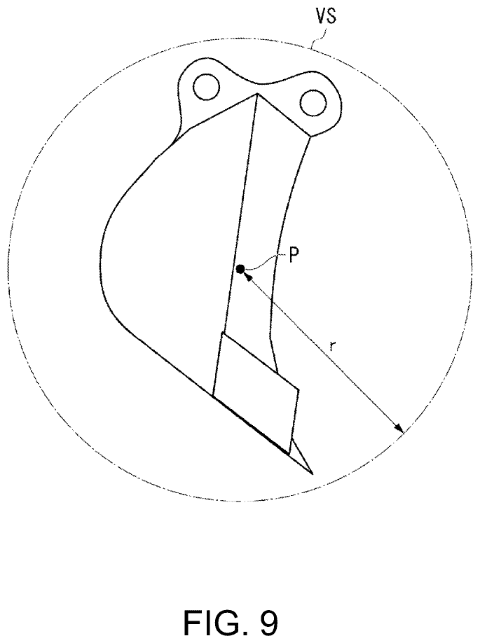

Furthermore, with the control device 200 according to the first embodiment, the control point P of the attachment 163 is set to the midpoint of the line segment connecting the midpoint of the rotation axis of the attachment 163 and the midpoint of the tip end portion of the attachment 163. Accordingly, the gap between the attachment 163 and the virtual sphere VS can be made small, and the operability of the work implement 160 by the operator is not impeded. Note that the control point P according to another embodiment is not limited thereto. For example, the control point P according to another embodiment may be the geometric center of the attachment 163 as illustrated in FIG. 9, or may be a point such that the virtual sphere VS that contains the attachment 163 is the smallest containing sphere. FIG. 9 is a diagram illustrating a relationship between a control point P and a virtual sphere VS according to a modification example of the first embodiment. In addition, the distance to the tip end portion of the attachment 163 of all the control point P, which is the midpoint of the line segment connecting the midpoint of the rotation axis of the attachment 163 and the midpoint of the tip end portion of the attachment 163, the control point P which is the geometric center of the attachment 163, and the control point P when virtual sphere VS becomes the smallest containing sphere, is shorter than the distance from the rotation axis of the attachment 163 to the tip end portion of the attachment 163. In this case, controllability can be improved compared to control using a virtual sphere VS with the control point P as the center of the rotation axis (arm top).

In addition, in other embodiments, the control point P may be the center of the rotation axis of the attachment 163. When the control point P is the center of the rotation axis of the attachment 163, the control point P is determined regardless of the rotation angle of the attachment 163, and therefore the coordinate transformation calculation using the attachment-vehicle body transformation matrix T^{at}_{sb} shown in equation (3) can be omitted.

Furthermore, the storage 250 of the control device 200 according to the first embodiment stores geometry data capable of identifying the position of the control point P and the radius r of the virtual sphere VS in association with the model number (type) of the attachment 163. The control device 200 reads, from the storage 250, geometry data associated with the model number of the attachment 163 attached to the work implement 160, and identifies the position of the control point P and the radius r of the virtual sphere VS. This eliminates the need to manually set the position of the control point P and the radius r of the virtual sphere VS every time the attachment 163 is replaced. In addition, the data capable of identifying the position of the control point P and the radius r of the virtual sphere VS may include the position of the control point P and the radius r of the virtual sphere VS, or may include data such as the position of the rotation axis, the position of the tip end portion, and the shape of the outer shell, which are necessary to obtain the control point P and the radius r.

### Second Embodiment

The work machine 100 according to the first embodiment includes a bucket as the attachment 163. In contrast, the work machine 100 according to a second embodiment includes a tiltrotator bucket including a tiltrotator 164 and a bucket 165 as the attachment 163. The tiltrotator 164 is an example of a movable portion of the attachment 163.

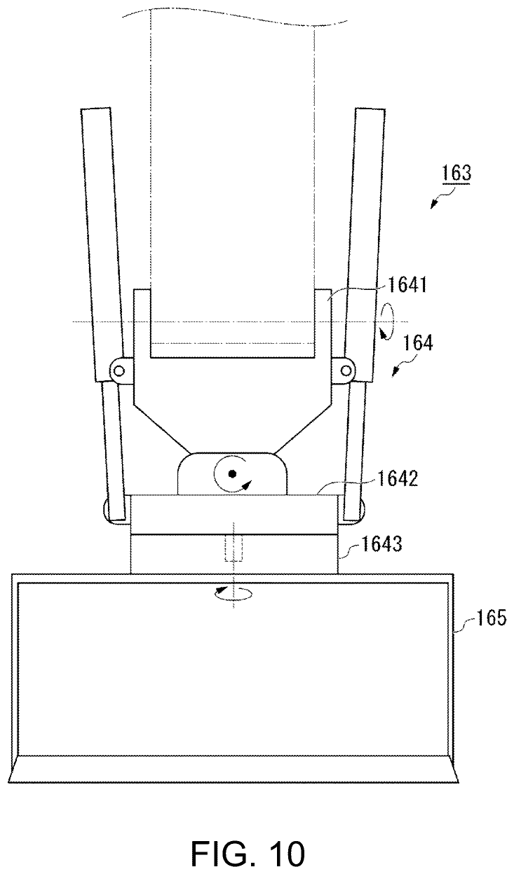

FIG. 10 is a diagram illustrating a configuration of the attachment 163 according to the second embodiment.

The tiltrotator 164 is attached to the tip end of the arm 162 to support the bucket 165. The tiltrotator 164 includes an attachment portion 1641, a tilt portion 1642, and a rotation portion 1643. The attachment portion 1641 is attached to the tip end of the arm 162 to be rotatable about an axis extending in the left-right direction in the drawing. The tilt portion 1642 is attached to the attachment portion 1641 to be rotatable about an axis extending in the front-rear direction in the drawing. The rotation portion 1643 is attached to the tilt portion 1642 to be rotatable about an axis extending in the up-down direction in the drawing. Ideally, the rotation axes of the attachment portion 1641, the tilt portion 1642, and the rotation portion 1643 are orthogonal to each other. The base end portion of the bucket 165 is fixed to the rotation portion 1643. Accordingly, the bucket 165 can rotate about three axes orthogonal to each other relative to the arm 162. However, in reality, the rotation axes of the attachment portion 1641, the tilt portion 1642, and the rotation portion 1643 may include design errors and need not necessarily be orthogonal to each other.

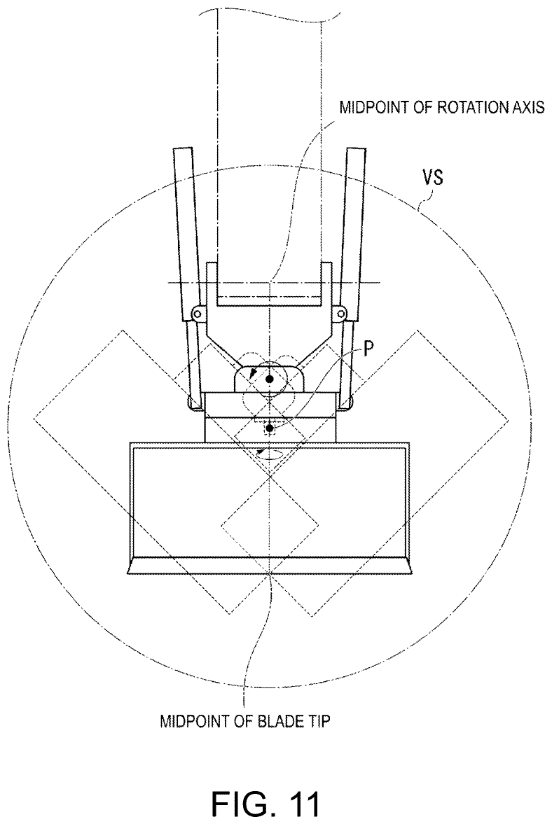

FIG. 11 is a diagram illustrating an example of a control point P and a virtual sphere VS according to the second embodiment.

The control point P of the attachment 163 according to the second embodiment is the midpoint of the line segment connecting the midpoint of the rotation axis of the attachment 163 (arm top) and the midpoint of the blade tip (tip end portion) of the bucket 165 when the inclination of the tilt portion 1642 is zero (reference posture). The control point P is defined in the attachment 163 coordinate system.

A radius r of the virtual sphere VS according to the second embodiment is equal to a distance from the control point P to the farthest point on the outer shell of the bucket 165. The farthest point at this time is the point farthest from the control point P in all postures that the tiltrotator 164 can take. Accordingly, it is possible to identify the control point P and the virtual sphere VS regardless of the inclination of the tilt portion 1642 and the rotation angle of the rotation portion 1643. Furthermore, even if the tiltrotator 164 does not include a sensor for measuring the inclination of the tilt portion 1642 or a sensor for measuring the rotation angle of the rotation portion 1643, the attachment 163 including the tiltrotator 164 can be prevented from entering the virtual wall VW. The control device 200 according to the second embodiment can obtain the control point P and the virtual wall VW of the attachment 163 having the tiltrotator 164 by calculations similar to those in the first embodiment.

In this way, the control device 200 sets the radius r of the virtual sphere VS to a length that will allow the virtual sphere VS to include the attachment 163 regardless of the posture of the movable portion, thereby enabling the entrance prevention control of the virtual wall VW using the virtual sphere VS to be realized by the same calculation regardless of whether or not the attachment 163 includes a movable portion.

### Third Embodiment

The work machine 100 according to a third embodiment includes a tiltrotator bucket having a tiltrotator 164 and a bucket 165 as the attachment 163, similarly to the second embodiment. On the other hand, the control device 200 according to the third embodiment differs from the second embodiment in the method of calculating the control point P and the virtual sphere VS.

Similarly to the second embodiment, the control point P according to the third embodiment is the midpoint of the line segment connecting the midpoint of the rotation axis of the attachment 163 (arm top) and the midpoint of the blade tip (tip end portion) of the bucket 165 when the inclination of the tilt portion 1642 is zero (reference posture). On the other hand, the control point P according to the third embodiment is defined not in the attachment coordinate system but in the bucket coordinate system that uses the midpoint of the rotation axis of the bucket 165 as the reference. Therefore, the position of the control point P in the attachment coordinate system changes depending on the posture of the tiltrotator 164.

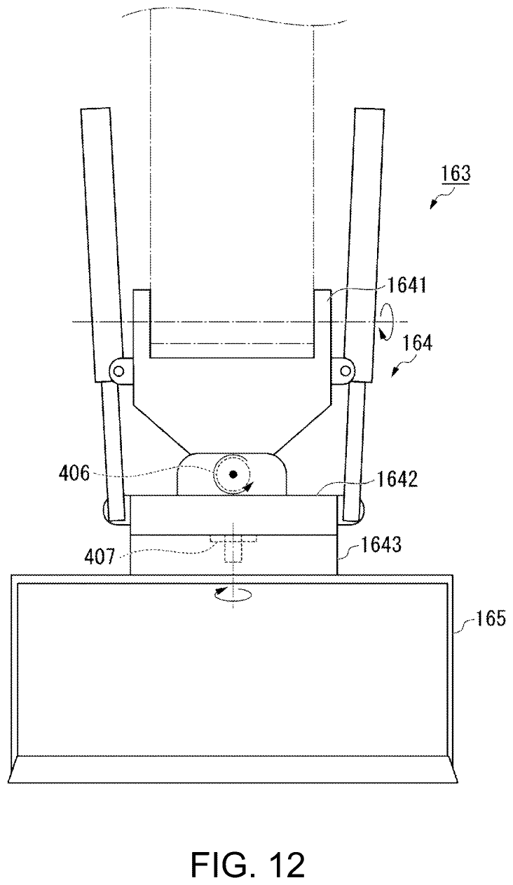

FIG. 12 is a diagram illustrating a configuration of the attachment 163 according to the third embodiment.

The tiltrotator 164 according to the second embodiment includes a tilt angle sensor 406 and a rotation angle sensor 407 around the rotation axis of the tilt portion 1642.

The tilt angle sensor 406 measures the tilt angle, which is the angle of the tilt portion 1642 with respect to the attachment portion 1641 of the tiltrotator 164. The tilt angle sensor 406 may be a rotation sensor provided on a joint shaft that rotatably connects the attachment portion 1641 and the tilt portion 1642. The measurement value of the tilt angle sensor 406 indicates zero when, for example, the rotation axis of the arm 162 and the rotation axis of the rotation portion 1643 are orthogonal to each other. In addition, the tilt angle sensor 406 according to another embodiment may be a stroke sensor that is attached to a tilt cylinder and converts the stroke amount into an angle. The tilt angle sensor 406 outputs tilt angle data, which is a measurement value, to the control device 200.

The rotation angle sensor 407 measures the rotation angle, which is the angle of the rotation portion 1643 with respect to the tilt portion 1642 of the tiltrotator 164. The rotation angle sensor 407 may be a rotation sensor provided in a rotation motor of the rotation portion 1643. The measurement value of the tilt angle sensor 406 indicates zero when, for example, the direction in which the blade tip of the bucket 165 is facing and the operation plane of the work implement 160 are parallel. The rotation angle sensor 407 outputs rotation angle data, which is a measurement value, to the control device 200.

### Calculation of Position Identification Unit 215

The position identification unit 215 generates a first tilt-arm transformation matrix T^{t1}ₐₘ for transforming from the first tiltrotator coordinate system to an arm coordinate system, based on a measurement value of an attachment angle θₐₜ acquired by the measurement value acquisition unit 214 and the geometry data of the arm 162, using the following equation (4). The first tilt-arm transformation matrix T^{t1}ₐₘ is a matrix that rotates around a Yₜ₁ axis by the attachment angle θₐₜ, translates by the deviation (xₜ₁, yₜ₁, zₜ₁) between the origin of the arm coordinate system and the origin of the first tiltrotator coordinate system, and further tilts by an inclination φₜ of the joint shaft of the tilt portion 1642. In addition, the position identification unit 215 generates a first tilt-vehicle body transformation matrix T^{t1}_{sb} for transforming from the first tiltrotator coordinate system to the vehicle body coordinate system by obtaining the product of the arm-vehicle body transformation matrix T^{am}_{sb} and the first tilt-arm transformation matrix T^{t1}ₐₘ. The method of calculating the arm-vehicle body transformation matrix T^{am}_{sb} is the same as that described in the first embodiment.

$$\begin{matrix}[ Math . 4 ] & \\ {T}_{am}^{t 1} = [ \begin{matrix}cos ( {θ}_{bk} - {ϕ}_{t} ) & 0 & sin ( {θ}_{bk} - {ϕ}_{t} ) & {x}_{t 1} \\ 0 & 1 & 0 & {y}_{t 1} \\ - sin ( {θ}_{bk} - {ϕ}_{t} ) & 0 & cos ( {θ}_{bk} - {ϕ}_{t} ) & {z}_{t 1} \\ 0 & 0 & 0 & 1\end{matrix} ] & ( 4 )\end{matrix}$$

The position identification unit 215 generates a second tilt-first tilt transformation matrix T^{t2}ₜ₁ for transforming from the first tiltrotator coordinate system to a second tiltrotator coordinate system, based on a measurement value of a tilt angle θₜ acquired by the measurement value acquisition unit 214 and the geometry data of the attachment 163, using the following equation (5). The second tilt-first tilt transformation matrix T^{t2}ₜ₁ is a matrix that rotates around an Xₜ₂ axis by the tilt angle θₜ, translates by the deviation (xₜ₂, yₜ₂, zₜ₂) between the origin of the first tiltrotator coordinate system and the origin of the second tiltrotator coordinate system, and further tilts by an inclination or of the rotation axis of the rotation portion 1643. In addition, the position identification unit 215 generates a second tilt-vehicle body transformation matrix T^{t2}_{sb} for transforming from the second tiltrotator coordinate system to the vehicle body coordinate system by obtaining the product of the first tilt-vehicle body transformation matrix T^{t1}_{sb} and the second tilt-first tilt transformation matrix T^{t2}ₜ₁.

$$\begin{matrix}[ Math . 5 ] & \\ {T}_{t 1}^{t 2} = [ \begin{matrix}1 & 0 & 0 & {x}_{t 2} \\ 0 & cos {θ}_{t} & - sin {θ}_{t} & {y}_{t 2} \\ 0 & sin {θ}_{t} & cos {θ}_{t} & {z}_{t 2} \\ 0 & 0 & 0 & 1\end{matrix} ] [ \begin{matrix}cos {ϕ}_{r} & 0 & sin {ϕ}_{r} & 0 \\ 0 & 1 & 0 & 0 \\ - sin {ϕ}_{r} & 0 & cos {ϕ}_{r} & 0 \\ 0 & 0 & 0 & 1\end{matrix} ] & ( 5 )\end{matrix}$$

The position identification unit 215 generates a bucket-second tilt transformation matrix T^{bk}ₜ₂ for transforming from the second tiltrotator coordinate system to a bucket coordinate system, based on a measurement value of a rotation angle θᵣ acquired by the measurement value acquisition unit 214 and the geometry data of the attachment 163, using the following equation (6). The bucket-second tilt transformation matrix T^{bk}ₜ₂ is a matrix that rotates around a Z_{bk} axis by the rotation angle θr and translates by the deviation (x_{bk}, y_{bk}, z_{bk}) between the origin of the second tiltrotator coordinate system and the origin of the bucket coordinate system. In addition, the position identification unit 215 generates a bucket-vehicle body transformation matrix T^{bk}_{sb} for transforming from the bucket coordinate system to the vehicle body coordinate system by obtaining the product of the second tilt-vehicle body transformation matrix T^{t2}_{sb} and the bucket-second tilt transformation matrix T^{bk}ₜ₂.

$$\begin{matrix}[ Math . 6 ] & \\ {T}_{t 2}^{bk} = [ \begin{matrix}cos {θ}_{r} & - sin {θ}_{r} & 0 & {x}_{bk} \\ sin {θ}_{r} & cos {θ}_{r} & 0 & {y}_{bk} \\ 0 & 0 & 1 & {z}_{bk} \\ 0 & 0 & 0 & 1\end{matrix} ] & ( 6 )\end{matrix}$$

The position identification unit 215 can obtain the product of the position of the control point P indicated by the geometry data of the attachment 163 and the bucket-vehicle body transformation matrix T^{bk}_{sb}, thereby obtaining the position of the control point P of the attachment 163 in the vehicle body coordinate system.

Note that when the attachment 163 does not include the tiltrotator 164, the measurement values of the tilt angle θₜ and the rotation angle θᵣ are not input to the control device 200. In this case, the position identification unit 215 treats the tilt angle θₜ and the rotation angle θᵣ as zero (as the reference posture). Accordingly, the position identification unit 215 can identify the position of the control point P of the attachment 163 using the same calculation method regardless of whether or not the tiltrotator 164 is present.

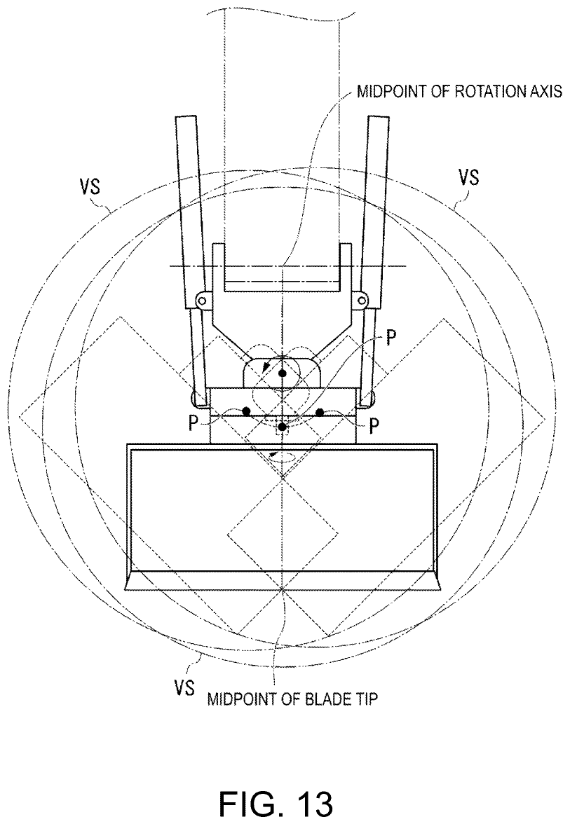

FIG. 13 is a diagram illustrating an example of a control point P and a virtual sphere VS according to the third embodiment. The control point P according to the third embodiment is defined in the bucket coordinate system. Therefore, the length from the control point P to the outer shell of the bucket 165 is determined regardless of the posture of the tiltrotator 164. Therefore, the control device 200 according to the third embodiment can make the radius r of the virtual sphere VS shorter than the radius r of the virtual sphere VS according to the second embodiment. Accordingly, the control device 200 according to the third embodiment can improve controllability compared to the second embodiment.

### OTHER EMBODIMENTS

An embodiment has been described above in detail with reference to the drawings, but a specific configuration is not limited to that described above, and various design changes and the like can be made. That is, in other embodiments, the order of the processing described above may be changed as appropriate. Further, some processing may be executed in parallel.

The control device 200 according to the embodiment described above may be constituted by a single computer. The configuration of the control device 200 may be divided into a plurality of computers, and the plurality of computers may cooperate with each other and serve as the control device 200. In this case, some of the computers constituting the control device 200 may be mounted inside the work machine 100, and other computers may be provided outside the work machine 100.

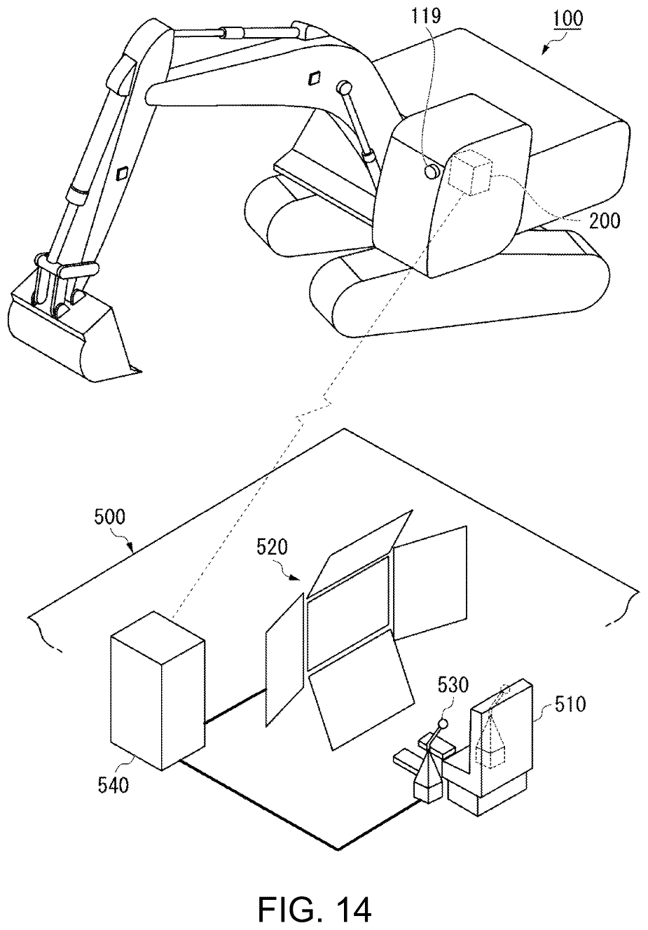

The work machine 100 according to the embodiment described above is operated by an operator who sits in the cab 180, but the work machine 100 according to another embodiment is not limited thereto. FIG. 14 is a diagram illustrating a configuration of a work system according to another embodiment. The work machine 100 according to another embodiment may be operated by a remote operation device 500 as illustrated in FIG. 14. The remotely operated work machine 100 further includes an imaging device 119 in addition to the configuration of the above-described embodiment, and the control device 200 transmits images captured by the imaging device 119 to the remote operation device 500 in real time. The remote operation device 500 includes an operator's seat 510, a display 520, an operation device 530, and a remote operation server 540. The remote operation server 540 causes the image received from the work machine 100 to be displayed on the display 520. Accordingly, the operator can recognize the situation around the remote work machine 100. Furthermore, the remote operation server 540 transmits operation signals from the operator on the operation device 530 to the work machine 100 via the network. The remote operation server 540 executes at least a part of the functions of the control device 200 according to the above embodiment. That is, in a work system including the remote operation server 540, the control device 200 and the remote operation server 540 constitute the work system.

Further, the control device 200 according to the embodiment described above performs a rotation conversion process on the virtual wall VW in order to treat the virtual wall VW as a plane, but the present disclosure is not limited thereto. For example, in another embodiment, when it is desired that the virtual wall VW functions as an annular wall surrounding the work machine 100, it is not necessary to perform the rotation conversion process of the virtual wall VW. In this case, the virtual wall VW is a curved surface. Note that the control device 200 according to another embodiment may perform the rotation conversion process on the virtual wall VW defined as a curved surface.

### REFERENCE SIGNS LIST

100 . . . Work machine 101 . . . Inclination measuring instrument 102 . . . Revolution angle sensor
103 . . . Boom angle sensor 104 . . . Arm angle sensor 105 . . . Attachment angle sensor 106 . . . Payload
meter 111 . . . Power source 112 . . . Hydraulic pump 113 . . . Control valve 114 . . . Travel motor
115 . . . Revolution motor 116 . . . Boom cylinder 117 . . . Arm cylinder 118 . . . Attachment cylinder
120 . . . Traveling body 140 . . . Revolving body 141 . . . Operation device 142 . . . Monitor device
160 . . . Work implement 161 . . . Boom 162 . . . Arm 163 . . . Attachment 164 . . . Tiltrotator
1641 . . . Attachment portion 1642 . . . Tilt portion 1643 . . . Rotation portion 165 . . . Bucket 180 . . . Cab
200 . . . Control device 210 . . . Processor 211 . . . Operation amount acquisition unit 212 . . . Input unit
213 . . . Display control unit
214 . . . Measurement value acquisition unit 215 . . . Position identification unit 216 . . . Generation unit
217 . . . Rotation conversion unit 218 . . . Intervention determination unit 219 . . . Intervention control
unit 220 . . . Control signal output unit 230 . . . Main memory 250 . . . Storage 270 . . . Interface 406 . . . Tilt
angle sensor 407 . . . Rotation angle sensor OW . . . Offset wall P . . . Control point VS . . . Virtual sphere
VW . . . Virtual wall

1. A system for controlling a work machine including a work implement provided with a work tool at a tip end, the system comprising:
a processor, wherein
the processor
identifies a virtual wall being a surface that prohibits entry of the work implement;
identifies a position of a control point of the work tool in the work machine;
identifies an offset wall obtained by bringing the virtual wall closer to the control point in a normal direction of the virtual wall by a length of a radius of a virtual sphere defined such that the virtual sphere includes the work tool with the control point as a center; and
controls the work machine such that the offset wall does not come into contact with the control point.

2. The system according to claim 1, wherein a distance from the control point to a tip end portion of the work tool is less than a distance from a rotation axis of the work tool to the tip end portion.

3. The system according to claim 2, wherein the control point is a midpoint of a line segment connecting a midpoint of the rotation axis of the work tool and a midpoint of the tip end portion of the work tool.

4. The system according to claim 1, wherein the radius of the virtual sphere is equal to a distance from the control point to a farthest point on an outer shell of the work tool.

5. The system according to claim 1, wherein
the work tool includes a movable portion, and
the control point is a point determined by an outer shell of the work tool when a posture of the movable portion is in a reference posture.

6. The system according to claim 5, wherein the virtual sphere includes the work tool regardless of the posture of the movable portion.

7. The system according to claim 5, wherein
the control point is defined in a coordinate system having a driven portion that is moved by the movable portion as reference, and
the processor identifies the position of the control point, based on the posture of the movable portion.

8. The system according to claim 1, wherein the processor reads, from a storage unit configured to store data that identifies the position of the control point and the radius of the virtual sphere in association with a type of the work tool, the data associated with the type of the work tool attached to the work implement, and identifies the position of the control point and the radius of the virtual sphere.

9. A method for controlling a work machine including a work implement provided with a work tool at a tip end, the method comprising:
identifying a virtual wall being a surface that prohibits entry of the work implement;
identifying a position of a control point of the work tool in the work machine;
identifying an offset wall obtained by bringing the virtual wall closer to the control point in a normal direction of the virtual wall by a length of a radius of a virtual sphere defined such that the virtual sphere includes the work tool with the control point as a center; and
controlling the work machine such that the offset wall does not come into contact with the control point.

10. A non-transitory computer storage medium storing a program, wherein the program causes a computer configured to control a work machine including a work implement provided with a work tool at a tip end to execute:
identifying a virtual wall being a surface that prohibits entry of the work implement;
identifying a position of a control point of the work tool in the work machine;
identifying an offset wall obtained by bringing the virtual wall closer to the control point in a normal direction of the virtual wall by a length of a radius of a virtual sphere defined such that the virtual sphere includes the work tool with the control point as a center; and
controlling the work machine such that the offset wall does not come into contact with the control point.

11. The system according to claim 2, wherein the radius of the virtual sphere is equal to a distance from the control point to a farthest point on an outer shell of the work tool.

12. The system according to claim 2, wherein
the work tool includes a movable portion, and
the control point is a point determined by an outer shell of the work tool when a posture of the movable portion is in a reference posture.

13. The system according to claim 12, wherein the virtual sphere includes the work tool regardless of the posture of the movable portion.

14. The system according to claim 2, wherein the processor reads, from a storage unit configured to store data that identifies the position of the control point and the radius of the virtual sphere in association with a type of the work tool, the data associated with the type of the work tool attached to the work implement, and identifies the position of the control point and the radius of the virtual sphere.
